(19) United States
(12) Patent Application Publication
(10) Pub. No.: US 2016/0347304 A1
(43) Pub. Date: Dec. 1, 2016

(54) HYBRID VEHICLE

(71) Applicant: Toyota Jidosha Kabushiki Kaisha, Toyota-shi Aichi-ken (JP)

(72) Inventor: Shunsuke Oyama, Nagakute-shi Aichi-ken (JP)

(21) Appl. No.: 15/166,769

(22) Filed: May 27, 2016

(30) Foreign Application Priority Data
May 29, 2015 (JP) 2015-109691

(51) Int. Cl. B60W 20/15; B60W 10/08; B60K 6/26; B60W 10/06; B60K 6/442; B60K 6/365

(52) U.S. Cl. CPC B60W 20/15; B60K 6/442; B60K 6/365; B60K 6/26; B60W 10/06; B60W 10/08; Y10S 903/91; Y10S 903/93; B60Y 2200/92; B60Y 2300/60; B60Y 2300/43; B60Y 2400/73; B60W 2540/10; B60W 2510/0638; B60W 2710/0644; B60W 2710/083

(57) ABSTRACT

In the case of motoring an engine by a first motor in reverse driving (S120, S130), a rate of increase Rup is set to provide a larger value at a lower required torque Tr* (larger absolute value) than a value at a higher required torque Tr* (smaller absolute value) (S180). A target rotation speed Ne* of the engine is increased by using the set rate of increase Rup (S190). The first motor is controlled to make rotation speed. Ne of the engine equal to the target rotation speed Ne* (S200, S210 and S240).

### CROSS-REFERENCE TO RELATED APPLICATIONS

The present disclosure claims priority to Japanese Patent. Application No. 2015-109691 filed May 29, 2015, which is incorporated herein by reference in its entirety including specification, drawings and claims.

### TECHNICAL FIELD

The present disclosure relates to a hybrid vehicle and more specifically a hybrid vehicle configured such that three rotational elements of a planetary gear are respectively connected with a rotating shaft of a first motor, an output shaft of an engine and a driveshaft linked with axle which are to be arrayed in the sequence of the rotating shaft, the output shaft and the driveshaft on a collinear diagram and that a second motor is connected with the driveshaft.

### BACKGROUND ART

In a proposed configuration of this type of hybrid vehicle, a carrier, a sun gear and a ring gear of a planetary gear are respectively connected with an engine, a first motor and a driveshaft linked with an axle, and a second motor is connected with the driveshaft. In reverse driving, motoring the engine by the first motor causes the friction of the engine to be used as an assist torque for reverse driving (for example, Patent Literature 1). In response to a need to use the friction of the engine as the assist torque for reverse driving in reverse driving, the hybrid vehicle of this configuration sets a friction power of the engine according to a required power corresponding to a required torque for driving, and sets the target rotation speed of the engine to meet this friction power. The first motor then starts motoring the engine with fuel cut, so as to rotate the engine at the target rotation speed. This enables the friction of the engine to be used as the assist torque for reverse driving.

### CITATION LIST

### Patent Literature

PTL 1: JP 2006-57617A

### SUMMARY

In the case of motoring the engine by the first motor to increase the rotation speed of the engine in reverse driving, this hybrid vehicle enables a torque applied to the driveshaft due to the inertia of the engine and the first motor (inertia-induced torque) as well as a torque applied to the driveshaft due to the friction of the engine (friction-induced torque) to be used as the assist torque for reverse driving. The magnitude of the inertia-induced torque becomes larger at the larger amount of increase (at the higher rate of increase) in rotation speed of the engine per unit time than at the lower rate of increase. The time period until the rotation speed of the engine reaches the target rotation speed becomes shorter at the high rate of increase in rotation speed of the engine than at the low rate of increase. This results in shortening the time period when the inertia-induced torque is produced. Because of these reasons, setting the rate of increase in rotation speed of the engine to a relatively large value irrespective of the magnitude of the required torque is likely to excessively increase the magnitude of the inertia-induced torque and excessively shorten the time period when the inertia-induced torque is produced, depending on the magnitude of the required torque.

With regard to the hybrid vehicle, an object of the present disclosure is to suppress the time period when the inertia-induced torque is produced from being excessively shortened, in the case of motoring the engine by the first motor in reverse driving.

In order to achieve the above primary object, the hybrid vehicle of the present disclosure employs the following configuration.

The present disclosure is directed to a hybrid vehicle. The hybrid vehicle includes an engine, a first motor that is configured to input and output power, a planetary gear that is configured to have three rotational elements respectively connected with a rotating shaft of the first motor, an output shaft of the engine and a driveshaft linked with an axle, such that the rotating shaft, the output shaft and the driveshaft are arrayed in this sequence on a collinear diagram, a second motor that is configured to input and output power to and from the driveshaft, a battery that is configured to transmit electric power to and from the first motor and the second motor, and a controller that is configured to control at least the second motor in reverse driving such that the hybrid vehicle runs according to a required torque for running. In the case of motoring the engine without fuel injection by the first motor in reverse driving, the controller sets a target rate of increase which denotes a target value of an amount of increase in rotation speed of the engine per unit time, such as to provide a larger value at a larger absolute value of the required torque than a value at a smaller absolute value of the required torque, and controls the first motor to increase rotation speed of the engine by the target rate of increase.

The hybrid vehicle of this aspect controls at least the second motor in reverse driving such as to run according to the required torque for driving. In the case of motoring the engine without fuel injection by the first motor in reverse driving, the target rate of increase that denotes the target value of the amount of increase in rotation speed of the engine per unit time is set to provide a larger value at the larger absolute value of the required torque than a value at the smaller absolute value of the required torque. The first motor is then controlled to increase the rotation speed of the engine by the target rate of increase. Compared with a configuration that sets the target rate of increase in rotation speed of the engine to a relatively large value irrespective of the magnitude of the required torque, this configuration suppresses the magnitude of a torque that is applied to the driveshaft due to the inertia of the engine and the first motor (hereinafter referred to as “inertia-induced torque”) from being excessively increased and suppresses the time period when the inertia-induced torque is produced from being excessively shortened.

In the hybrid vehicle of this aspect, the controller may start motoring the engine by the first motor when the absolute value of the required torque becomes larger than a threshold value in reverse driving. Here, a rated torque of the second motor may be used as the threshold.

Further, in the hybrid vehicle of this aspect, in the case of motoring the engine by the first motor in reverse driving, the controller may set a required rotation speed such as to provide a larger value at the larger absolute value of the required torque than a value at the smaller absolute value of the required torque and control the first motor to increase the rotation speed of the engine to the required rotation speed. As described above, the target rate of increase of the engine is set to provide a larger value at the larger absolute value of the required torque than a value at the smaller absolute value of the required torque. This results in setting the required rotation speed such as to provide a larger value at the larger absolute value of the required torque than a value at the smaller absolute value of the required torque. This ensures some time period until the rotation speed of the engine reaches the required rotation speed, even in the case of a relatively large absolute value of the required torque. This results in ensuring some time period when the inertia-induced torque is produced, even in the case of a relatively large absolute value of the required torque.

### BRIEF DESCRIPTION OF DRAWINGS

FIG. 1 is a configuration diagram illustrating the schematic configuration of a hybrid vehicle according to one embodiment of the present disclosure;

FIG. 2 is a flowchart showing one example of a reverse driving control routine performed by HVECU of the embodiment;

FIG. 3 is one example of a required torque setting map;

FIG. 4 is one example of a required rotation speed setting map;

FIG. 5 is one example of a increase rate setting map;

FIG. 6 is one example of collinear diagram illustrating the dynamic relationship between the rotation speed and the torque with regard to the rotational elements of a planetary gear in the case of reverse driving with motoring an engine without fuel injection by motor MG1; and

FIG. 7 is a diagram illustrating one example of time changes of an accelerator position, a vehicle speed, a required torque, a required rotation speed and a rotation speed of an engine, a transmission torque and a torque output to a driveshaft in reverse driving.

### DESCRIPTION OF EMBODIMENTS

The following describes some aspects of the present disclosure with reference to embodiments.

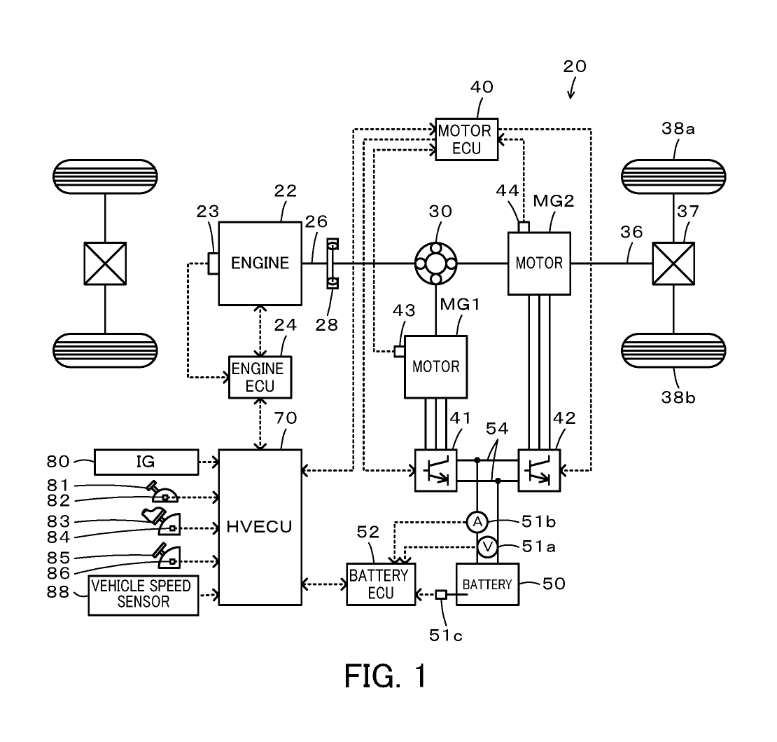

FIG. 1 is a configuration diagram illustrating the schematic configuration of a hybrid vehicle 20 according to one embodiment of the present disclosure. As shown in FIG. 1, the hybrid vehicle 20 of the embodiment includes an engine 22, a planetary gear 30, motors MG1 and MG2, inverters 41 and 42, a battery 50 and a hybrid electronic control unit (hereinafter referred to as HVECU) 70.

The engine 22 is configured as an internal combustion engine that output power using, for example, gasoline or light oil as fuel. This engine 22 is operated and controlled by an engine electronic control unit (hereinafter referred to as engine ECU) 24.

The engine ECU 24 is implemented by a CPU-based microprocessor and includes a ROE that stores processing programs, a RAM that temporarily stores data, input and output ports and a communication port other than the CPU, although not signals from various sensors required for operation control of the engine 22. Examples of the signals input into the engine ECU 24 include:

crank angle θcr from a crank position sensor 23 configured to detect the rotational position of a crankshaft 26 of the engine 22; and

throttle position TH from a throttle valve position sensor configured to detect the position of a throttle valve.

The engine ECU 24 outputs, via its output port, various control signals for operation control of the engine 22. Examples of the control signals output from the engine ECU 24 include:

control signal to a throttle motor configured to adjust the position of a throttle valve;

control signal to a fuel injection valve; and

control signal to an ignition coil integrated with an igniter.

The engine ECU 24 is connected with the HVECU 70 via their communication ports to perform, operation control of the engine 22 in response to control signals from the HVECU 70 and output data regarding the operating conditions of the engine 22 to the HVECU 70 as appropriate. The engine ECU 24 computes the rotation speed of the crankshaft 26, which is equal to a rotation speed Ne of the engine 22, based on the crank position θcr detected by the crank position sensor 23.

The planetary gear 30 is configured as a single pinion-type planetary gear mechanism. The planetary gear 30 includes a sun gear that is connected with a rotor of the motor MG1. The planetary gear 30 also includes a ring gear that is connected with a driveshaft 36 linked with drive wheels 38a and 38b via a differential gear 37. The planetary gear 30 also includes a carrier that is connected with the crankshaft 26 of the engine 22 via a damper 28.

The motor MG1 is configured, for example, as a synchronous motor generator. The motor MG1 includes the rotor that is connected with the sun gear of the planetary gear 30 as described above. The motor MG2 is also configured, for example, as a synchronous motor generator. The motor MG2 includes a rotor that is connected with the driveshaft 36. The inverters 41 and 42 are connected with the battery 50 via power lines 54. The motors MG1 and MG2 are rotated and driven by switching control of a plurality of switching elements (not shown) of the inverters 41 and 42 by a motor electronic control unit (hereinafter referred to as “motor ECU”) 40.

The motor ECU 40 is implemented by a CPU-based microprocessor and includes a RUM that stores processing programs, a RAM that temporarily stores data, input and output ports and a communication port other than the CPU, although not being illustrated. The motor ECU 40 inputs, via its input port, signals from various sensors required for drive control of the motors MG1 and MG2. Examples of the signals input into the motor ECU 40 include:

rotational positions θml and θm2 from rotational position detection sensors 43 and 44 configured to detect the rotational positions of the rotors of the motors MG1 and MG2; and

phase currents from current sensors configured to detect electric:currents flowing through the respective phases of the motors MG1 and MG2.

The motor ECU 40 outputs, via its output port, for example, switching control signals to the switching elements (not shown) of the inverters 41 and 42. The motor ECU 40 is connected with the HVECU 70 via the respective communication ports and performs drive control of the motors MG1 and MG2 in response to controls signals from the HVECU 70, whole outputting data regarding the driving conditions of the motors MG1 and MG2 to the HVECU 70 as appropriate. The motor ECU 40 computes rotation speeds Nm1 and Nm2 of the motors MG1 and MG2, based on the rotational positions θm1 and θm2 of the rotors of the motors MG1 and MG2 from the rotational position detection sensors 43 and 44.

The battery 50 is configured, for example, as a lithium ion secondary battery or a nickel metal hydride secondary battery. This battery 50 is connected with the inverters 41 and 42 via the power lines 54 as described above. The battery 50 is under management of a battery electronic control unit (hereinafter referred to as “battery ECU”) 52.

The battery ECU 52 is implemented by a CPU-based microprocessor and includes a ROM that stores processing programs, a RAM that temporarily stores data, input and output ports and a communication port other than the CPU, although not being illustrated. The battery ECU 52 inputs, via its input port, signals from various sensors required for management of the battery 50. Examples of the signals Input into the battery ECU 52 include:

battery voltage Vb from a voltage sensor 51a placed between terminals of the battery 50;

battery current Ib from a current sensor 51b mounted to an output terminal of the battery 50; and

battery temperature Tb from a temperature sensor 51c mounted to the battery 50.

The battery ECU 52 is connected with the HVECU 70 via the respective communication ports and outputs data regarding the conditions of the battery 50 to the HVECU 70 as appropriate. The battery ECU 52 computes a state of charge SOC, based on an integrated value of the battery current Ib from the current sensor 51b. The state of charge SOC denotes a ratio of power capacity dischargeable from the battery 50 to the entire capacity of the battery 50.

The HVECU 70 is implemented by a CPU-based microprocessor and includes a ROM that stores processing programs, a RAM that temporarily stores data, input and output ports and a communication port other than the CPU, although not being illustrated. The HVECU 70 inputs, via its input port, signals from various sensors. Examples of the signals input into the HVECU 70 include:

ignition signal from an ignition switch 80;

shift position SP from a shift position sensor 82 configured to detect the operational position of a shift lever 81;

accelerator position Acc from an accelerator pedal position sensor 84 configured to detect the depression amount of an accelerator pedal 83;

brake pedal position BP from a brake pedal position sensor 86 configured to detect the depression amount of a brake pedal 85; and

vehicle speed V from a vehicle speed sensor 88.

As described above, the HI/ECU 70 is connected with the engine ECU 24, the motor ECU 40 and the battery ECU 52 via their communication ports to transmit various control signals and data to and from the engine ECU 24, the motor ECU 40 and the battery ECU 52.

The hybrid vehicle 20 of the embodiment provides a parking position (P position) used for parking, a reverse position (R position) for reverse driving, a neutral position (N position) at a neutral gear and a drive position (D position) for forward driving, as the operational position of the shift lever 81 (shift position SP detected by the shift position sensor 82).

The hybrid vehicle 20 of the embodiment having the above configuration sets a required driving power for the driveshaft 36 based on the accelerator position Acc and the vehicle speed V and performs operation control of the engine 22 and the motors MG1 and MG2 so as to output a required power that meets the required driving power to the driveshaft 36. The hybrid vehicle 20 has the following three modes (1) to (3) as the operation mode of the engine 22 and the motors MG1 and MG2:

(1) torque conversion drive mode: mode that performs operation control of the engine 22 so as to output a power corresponding the required power from the engine 22, while performing drive control of the motors MG1 and MG2 so as to cause all the power output from the engine 22 to be subjected to torque conversion by the planetary gear 30 and the motors MG1 and MG2 and thereby output the required power to the driveshaft 36;

(2) charge-discharge drive mode: mode that performs operation control of the engine 22 so as to output a power that meets the sum of the required power and electric power required for charging or discharging the battery 50, from the engine 22, while performing drive control of the motors MG1 and MG2 so as to cause all the power or part of the power output from the engine 22 to be subjected to torque conversion by the planetary gear 30 and the motors MG1 and MG2 accompanied with charging or discharging of the battery 50 and thereby output the required power to the driveshaft 36; and

(3) motor drive mode: mode that performs drive control of the motor MG2 so as to output the required power to the driveshaft 36, while stopping the operation of the engine 22.

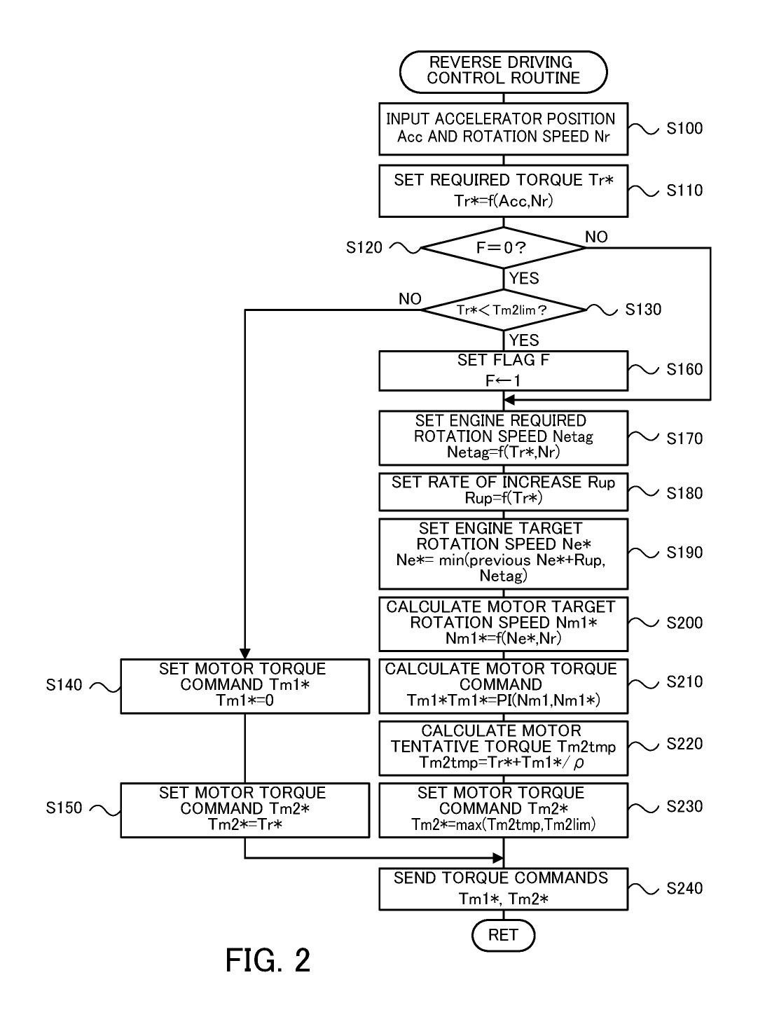

The following describes the operations of the hybrid vehicle 20 of the embodiment having the above configuration or more specifically the operations for reverse driving. FIG. 2 is a flowchart showing one example of a reverse driving control routine performed by the HVECU 70 of the embodiment. This routine is repeatedly performed at predetermined time intervals (for example, every several msec) at the shift position SP set to the reverse driving position.

On start of the reverse driving control routine, the HVECU 70 first input data including the accelerator position Acc and a rotation speed Nr of the driveshaft 36 (step S100). The accelerator position Acc input here is the value detected by the accelerator pedal position sensor 84. The rotation speed Nm2 of the motor MG2 computed by the motor ECU 40 is input by communication to be used as the rotation speed Nr of the driveshaft 36.

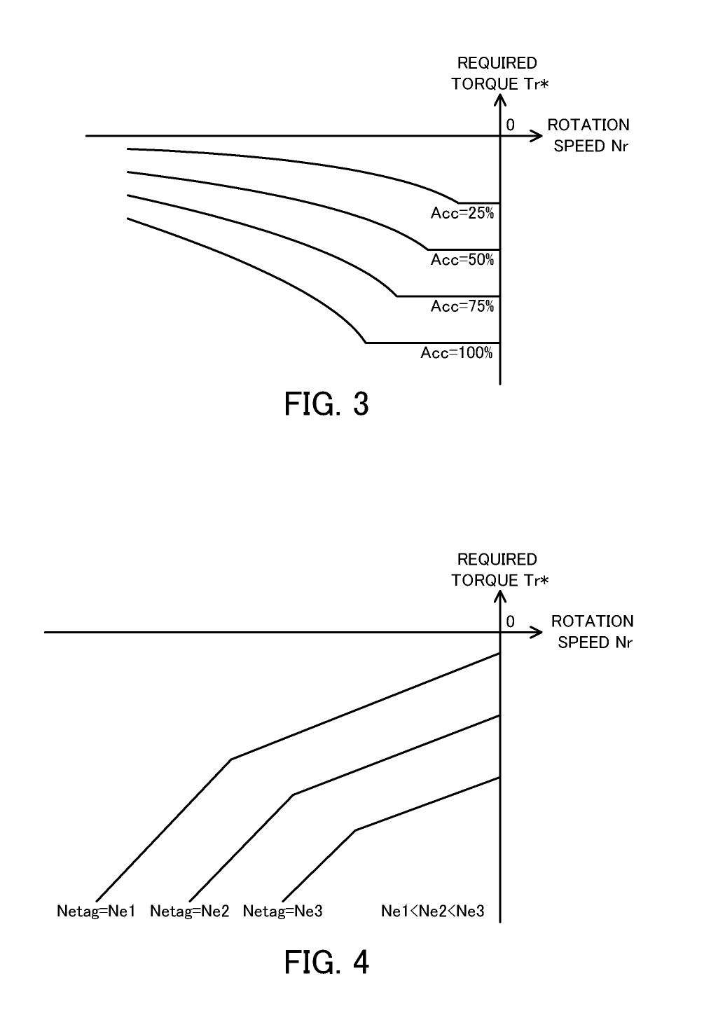

After inputting the data, the HVECU 70 sets a required torque Tr* required for driving (required for the driveshaft 36), based on the input accelerator position Acc and the input rotation speed Nr of the driveshaft 36 (step S110). According to this embodiment, a procedure of setting the required torque Tr* specifies and stores in advance a relationship of the required torque Tr* to the accelerator position Acc and the rotation speed Nr of the driveshaft 36 in the form of a required torque setting map in the ROM (not shown), and reads and sets the required torque Tr* corresponding to a given accelerator position Acc and a given rotation speed Nr from this map. One example of the required torque setting map is shown in FIG. 3. As illustrated, negative values are set to the required torque Tr* at the shift position SP set to the reverse driving position.

The HVECU 70 subsequently determines whether a flag F is equal to value 0 or value 1 (step S120). When the flag F is equal to the value 0, the HVECU 70 compares the required torque Tr* with a negative rated torque Tm2lim of the motor MG2 (step S130). The comparison of step S130 aims to determine whether the required torque Tr* can be covered by only the torque from the motor MG2. The flag F is set to the value 0 as the initial value when the shift position SP is set to the reverse driving position and is changed over from the value 0 to the value 1 when the required torque Tr* becomes less than the rated torque Tm2lim of the motor MG2. The case where the required torque Tr* becomes less than the rated torque Tm2lim of the motor MG2 may be, for example, the case where the hybrid vehicle e 20 tries to ride over a step in the reverse direction or the case where the hybrid vehicle 20 is stuck in a ditch.

When the required torque Tr* is equal to or greater than the rated torque Tm2lim of the motor MG2 (when the absolute value of the required torque Tr* is equal to or less than the absolute value of the rated torque Tm2lim) at step S130, the HVECU 70 determines that the required torque Tr* can be covered by only the torque from the motor MG2. The HVECU 70 then sets a torque command Tm1* of the motor MG1 to value 0 (step S140) and sets a torque command Tm2* of the motor MG2 to the required torque Tr* (step S150).

After setting the torque commands Tm1* and Tm2* of the motors MG1 and MG2, the HVECU 70 sends the set torque commands Tm1* and Tm2* to the motor ECU 40 (step S240) and terminates this routine. When receiving the torque commands Tm1* and Tm2*, the motor ECU 40 performs switching control of the switching elements of the inverters 41 and 42 so as to drive the motors MG1 and MG2 with the torque commands Tm1* and Tm2*.

When the required torque Tr* becomes less than the rated torque Tm2lim (when the absolute value of the required torque Tr* is larger than the absolute value of the rated torque Tm2lim), on the other hand, the HVECU 70 determines that the required torque Tr* cannot be covered by only the torque from the motor MG2 and sets the flag F to the value 1 (step S160). When the flag F is changed over from the value 0 to the value 1, motoring the engine 22 without fuel injection by the motor MG1 is started as described later.

The HVECU 70 subsequently sets a required rotation speed Netag of the engine 22, based on the required torque Tr* and the rotation speed Nr of the driveshaft 36 (step S170) According to this embodiment, a procedure of setting the required rotation speed Netag of the engine 22 specifies and stores in advance a relationship of the required rotation speed Netag of the engine 22 to the required torque Tr* and the rotation speed Nr of the driveshaft 36 in the form of a required rotation speed setting map in the ROM (not shown), and reads and sets the required rotation speed Netag of the engine 22 corresponding to a given required torque Tr* and a given rotation speed Nr of the driveshaft 36 from this map. One example of the required rotation speed setting map is shown in FIG. 4. In the map of FIG. 4, “Ne1”, “Ne2” and “Ne3” may be respectively, for example, about 1000 rpm, about 2000 rpm and about 3000 rpm. As illustrated, the required rotation speed Netag of the engine 22 is set to decrease with a decrease in rotation speed Nr of the driveshaft 36 or more specifically to provide a smaller value at the lower rotation speed Pr of the driveshaft 36 (larger absolute value, i.e., farther from the value 0) than a value at the higher rotation speed Pr of the driveshaft 36 (smaller absolute value, i.e., closer to the value 0). The required rotation speed Netag of the engine 22 is also set to increase with a decrease in required torque Tr* or more specifically to provide a larger value at the lower required torque Tr* (larger absolute value, i.e., farther from the value 0) than a value at the higher required torque Tr* (smaller absolute value, i.e., close to the value 0). The reason of such setting will be described later.

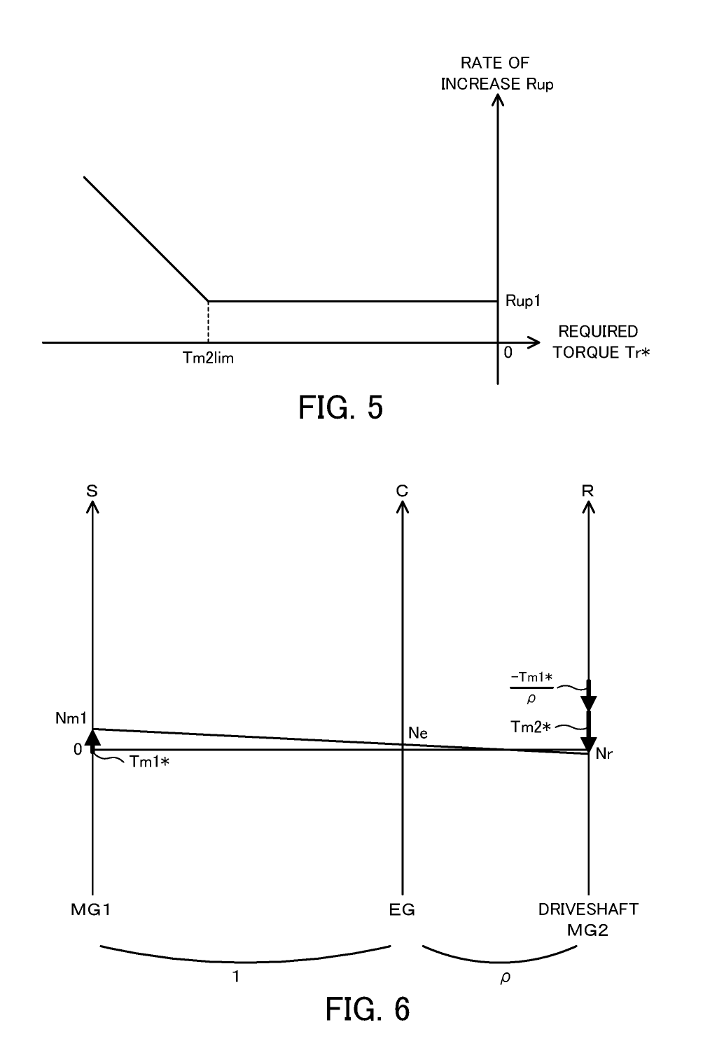

The HVECU 70 subsequently sets a rate of increase Rup of a target rotation speed Ne* of the engine 22, based on the required torque Tr* (step S180). The HVECU 70 then sets the target rotation speed Ne* of the engine 22 by limiting the sum of a previous target rotation speed (previous Ne*) of the engine 22 and the rate of increase Rup with the required rotation speed Netag (upper limit guarding) according to Equation (1) given below (step S190). The target rotation speed Ne* of the engine 22 is set to value 0 until the flag F is changed over from the value 0 to the value 1. The rate of increase Rup denotes an amount of increase of the target rotation speed Ne* per unit time (execution interval of this routine) when the target rotation speed Ne* of the engine 22 is increased toward the required rotation speed Netag. According to this embodiment, a procedure of setting the rate of increase Rup specifies and stores in advance a relationship of the rate of increase Rup to the required torque Tr* in the form of an increase rate setting map in the RAM (not shown), and reads and sets the rate of increase Rup corresponding to a given required torque Tr* from this map. One example of the increase rate setting map is shown in FIG. 5. As illustrated, in a range of the required torque Tr* equal to or greater than the rated torque Tm2lim of the motor MG2, the rate of increase Rup is set to a relatively low predetermined value Rup1 in a positive range (converted value per execution interval of this routine that is converted from, for example, 0.4 rpm/msec, 0.5 rpm/msec or 0.6 rpm/msec). In a range of the required torque Tr* less than the rated torque Tm2lim, on the other hand, the rate of increase Rup is set to increase with a decrease in required torque Tr* or more specifically to provide a larger value at the lower required torque Tr* (larger absolute value, i.e., farther from the rated torque Tm2lim) than a value at the higher required torque Tr* (smaller absolute value, i.e., closer to the rated torque Tm2lim). The reason of such setting will be described later. The processing of step S190 gradually increases the target rotation speed Ne* of the engine 22 toward the required rotation speed Netag by the rate of increase Rup and keeps the target rotation speed Ne* at the required rotation speed Netag after reaching the required rotation speed Netag.

Ne*=min(previous Ne*+Rup, Netag) (1)

After setting the target rotation speed Ne* of the engine 22, the HVECU 70 calculates a target rotation speed Nm1* of the motor MG1 from the target rotation speed Ne* of he engine 22, the rotation speed Nr of the driveshaft 36 and a gear ratio ρ of the planetary gear 30 (number of teeth of sun gear/number of teeth o ring gear) according to Equation (2) given below (step 3200). The HVECU 70 subsequently calculates a torque command Tm1* of the motor MG1 according to Equation (3) given below from the calculated target rotation speed Nm1* of the motor MG1, the current rotation speed Nm1 of the motor MG1 and the gear ratio ρ of the planetary gear 30 (step S210) Equation (2) is a dynamic relational expression with regard to the rotational elements of the planetary gear 30. One example of collinear diagram shown in FIG. 6 illustrates the dynamic relationship between the rotation speed and the torque with regard to the rotational elements of the planetary gear 30 in the case of reverse driving with motoring the engine 22 without fuel injection by the motor MG1. In the diagram, an axis S on the left side shows a rotation speed of the sun gear that is equal to the rotation speed Nm1 of the motor MG1. An axis C shows a rotation speed of the carrier that is equal to the rotation speed Ne of the engine 22. An axis R shows the rotation speed Nr of the ring gear (driveshaft 36) that is equal to the rotation speed Nm2 of the motor MG2. Two thick arrows on the axis R indicate a torque (−Tm1*/ρ) that is output from the motor MG1 and is applied to the driveshaft 36 via the planetary gear 30 when the motor MG1 is driven with the torque command Tm1* and a torque that is output from the motor MG2 and is applied to the driveshaft 36 when the motor MG2 is driven with the torque command Tm2*. In the description below, the torque (−Tm1*/ρ) is expressed as transmission torque Tmp. The transmission torque Trap includes a torque applied to the driveshaft 36 due to friction of the engine 22 (hereinafter referred to as “friction-induced torque”) and a torque applied to the driveshaft 36 due to inertia of the engine 22 and the motor MG1 (hereinafter referred to as “inertia-induced torque”). The magnitude of the friction-induced torque provides a larger value at the higher rotation speed Ne of the engine 22 (higher target rotation speed Ne*) than a value at the lower rotation speed Ne. The magnitude of the inertia-induced, torque provides a larger value at the larger amount of increase in rotation speed Ne of the engine 22 per unit time (higher rate of increase, farther from the value 0) than a value at the lower rate of increase (closer to the value 0). Equation (2) can be readily led from this collinear diagram. Equation (3) is a relational expression in feedback control to rotate the motor MG1 at the target rotation speed Nm1* (i.e., to rotate the engine 22 at the target rotation speed Ne*). In Equation (3), “k1” denotes a gain of proportional and “k2” denotes a gain of integral term.

Nm1*=Ne*·(1+ρ)/ρ−Nr/·ρ (2)

Tm1*=(Nm1*−Nm1)+k2·∫(Nm1*−Nm1)dt (3)

The HVECU 70 subsequently calculates a tentative torque Tm2tmp of the motor MG2 by subtracting the transmission torque Tmp(=−Tm1/ρ) from the required torque Tr* according to Equation (4) given below (step S220) and sets a torque command Tm2* of the motor MG2 by limiting the calculated tentative torque Tm2tmp with the rated torque Tm2lim (lower limit guarding) according to Equation (5) given below (step S230).

The HVECU 70 then sends the set torque commands Tm1* and Tm2* to the motor ECU 40 (step S240) and terminates this routine. When receiving the torque commands Tm1* and Tm2*, the motor ECU 40 performs switching control of the switching elements of the inverters 41 and 42 so as to drive the motors MG1 and MG2 with the torque commands Tm1* and Tm2*.

Tm2tmp=Tr*+Tm1/ρ (4)

Tm2*=max(Tm2tmp,Tm2lim) (5)

The following describes the required rotation speed setting map of FIG. 4 (relationship of the required rotation speed Netag of the engine 22 to the required torque Tr* and the rotation speed Nr of the driveshaft 36) and the increase rate setting map of FIG. 5 (relationship of the rate of increase Rup to the required torque Tr*).

The following describes the relationship of the rate of increase Rup to the required torque Tr* in the increase rate setting map of FIG. 5. It is here assumed that the required torque Tr* is less than the rated torque Tm2lim of the motor MG2. Increasing the rate of increase Rup provides a larger magnitude of the inertia-induced torque, compared with decreasing the rate of increase Rup. Increasing the rate of increase Rup, however, leads to the shorter time period until the rotation speed. Ne of the engine 22 (target rotation speed Ne*) reaches the required rotation speed Netag and thereby provides a shorter time period when the inertia-induced torque is produced, compared with decreasing the rate of increase Rup. Using a relatively large value as the rate of increase Rup irrespective of the required torque Tr* is likely to provide an excessively large magnitude of the inertia-induced torque and an excessively short time period when the inertia-induced torque is produced in the case of a relatively high required torque Tr* (relatively small absolute value, i.e., relatively closer to the rated torque Tm2lim). The procedure of the embodiment take account of this likelihood and sets the rate of increase Rap to provide a larger value at the lower required torque Tr* than a value at the higher required torque Tr* when the required torque Tr* less than the rated torque Tm2lim of the motor MG2. This suppresses the magnitude of the inertia-induced torque from being excessively increased and suppresses the time period when the inertia-induced torque is produced from being excessively shortened. Suppressing the magnitude of the inertia-induced torque from being excessively increased results in suppressing the magnitude of the transmission torque Tmp from being excessively increased (i.e., suppressing the transmission torque Tmp from becoming excessive to an excess (Tr*−Tm2lim) of the required torque Tr* relative to the rated torque Tm2lim of the motor MG2. Basically the transmission torque Tmp has a greater loss than the torque output from the motor MG2 to the driveshaft 36. Suppressing the magnitude of the transmission torque Trap from being excessively increased accordingly suppresses an increase in total loss of the vehicle caused by the excessively increased magnitude of the transmission torque Tmp and thereby suppresses reduction of the total energy efficiency of the vehicle.

The following describes the relationship of the required rotation speed Netag of the engine 22 to the rotation speed Nr of the driveshaft 36 in the required rotation speed setting map of FIG. 4. As understood from the collinear diagram of FIG. 6, the lower rotation speed Nr of the driveshaft 36 provides the lower rotation speed Ne of the engine 22 relative to the rotation speed Nm1 of the motor MG1, i.e., the smaller value (MNe−Nm1) and provides the higher rotation speed of the pinion gear of the planetary gear 30 (on the assumption that the rotating direction is positive when the motor MG1 has positive rotation speed Nm1), compared with the higher rotation speed Nr of the driveshaft 36. Accordingly the lower rotation speed Nr of the driveshaft 36 provides the lower rotation speed Ne of the engine 22 corresponding to the upper limit rotation speed of the motor MG1 and provides the lower rotation speed Ne of the engine 22 corresponding to the upper limit rotation speed of the pinion gear of the planetary gear 30, compared with the higher rotation speed Nr of the driveshaft 36. The procedure of the embodiment take account of this characteristic and sets the required rotation speed Netag of the engine 22 to provide a smaller value at the lower rotation speed Nr of the driveshaft 36 than a value at the higher rotation speed Nr of the driveshaft 36. Such setting protects the relevant parts.

The following describes the relationship of the required rotation speed Netag of the engine 22 to the required torque Tr* in the required rotation speed setting map of FIG. 4. As described above, the procedure of the embodiment sets the rate of Increase Rup to provide a larger value at the lower required torque Tr* than a value at the higher required torque Tr* when the required torque Tr* is less than the rated torque Tm2lim of the motor MG2 as described above. In the case of relatively low required torque Tr*, it is thus likely to shorten the time period until the target rotation speed Ne of the engine 22 reaches the required rotation speed Netag. The procedure of the embodiment takes account of this likelihood and sets the required rotation speed. Netag of the engine 22 to provide a larger value at the lower required torque Tr* than a value at the higher required torque Tr*. This ensures some time period until the target rotation speed. Ne* of the engine 22 reaches the required rotation speed Netag, even in the case of a relatively low required torque Tr*. This results in ensuring some time period when the inertia-induced torque is produced, even in the case of a relatively low required torque Tr*.

When the flag F is equal to the value 1 at step S120, the HVECU 70 determines that motoring the engine 22 by the motor MG1 has been started. The HVECU 70 accordingly performs the processing of steps S170 to S240 with skipping the processing of step S130 (comparing the required torque Tr* with the rated torque Tm2lim of the motor MG2) and terminates the routine. Motoring the engine 22 by the motor MG1 accordingly continues in the case where the required torque Tr* becomes less than the rated torque Tm2lim of the motor MG2 and subsequently increases to or above the rated torque Tm2lim.

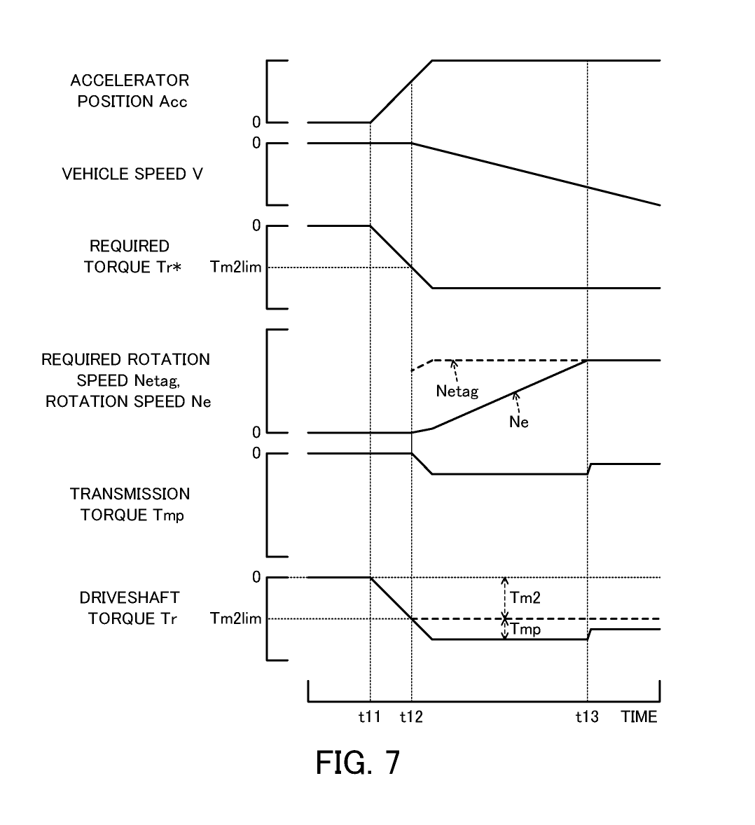

FIG. 7 is a diagram illustrating one example of time changes of the accelerator position Acc, the vehicle speed V, the required torque Tr*, the required rotation speed Netag and the rotation speed Ne of the engine 22, the transmission torque Tmp and the torque Tr output to the driveshaft 36 in reverse driving. In the illustrated example of FIG. 7, at a time t11, the accelerator position Acc starts increasing and the required torque Tr* starts decreasing (increasing as the absolute value). When the required torque Tr* becomes less than the rated torque Tm2lim at a time t12, it is determined to start motoring the engine 22 without fuel injection by the motor MG1. After the time t12, the required rotation speed Netag of the engine 22 and the rate of increase Rup are set according to the required torque Tr*, and the target rotation speed. Ne* of the engine 22 is increased toward the required rotation speed Netag by using the rate of increase Rup. Motoring the engine 22 by the motor MG1 is started to make the rotation speed Ne of the engine 22 equal to the target rotation speed Ne*. In this state, the magnitude of the torque Tr to be output to the driveshaft 36 is increased by the transmission torque Tmp including the friction-induced torque and the inertia-induced torque. The rate of increase Rup is set to provide a larger value at the lower required torque Tr* than a value at the higher required torque Tr*. This suppresses the magnitude of the inertia-induced torque from being excessively increased and suppresses the time period when the inertia-induced torque is produced from being excessively shortened, thus suppressing reduction of the total energy efficiency of the vehicle. The required rotation speed Netag of the engine 22 is set to provide a larger value at the lower required torque Tr* than a value at the higher required torque Tr*. This ensures some time period when the inertia-induced torque is produced, even in the case of a relatively low required torque Tr*. After a time t13 when the target rotation speed Ne* of the engine 22 reaches the required rotation speed Netag, the target rotation speed Ne* is set to the required rotation speed. Netag, and motoring the engine 22 by the motor MG1 is performed to make the rotation speed Ne of the engine 22 equal to the target rotation speed Ne*. In this state, the inertia-induced torque is not included in the transmission torque Tmp. This accordingly reduces the magnitude of the torque Tr output to the drive shaft 36.

As described above, the hybrid vehicle 20 of the embodiment sets the rate of increase Rup to provide a larger value at the lower required torque Tr* (larger absolute value) than a value at the higher required torque Tr* (smaller absolute value) in the case of motoring the engine 22 by the motor MG1 in reverse driving, and increases the target rotation speed Ne* of the engine 22 by using the set rate of increase Rup. The motor MG1 and the motor MG2 are control led to drive the hybrid vehicle 20 according to the required torque Tr* when the rotation speed Ne of the engine 22 becomes equal to the target rotation speed Ne*. This suppresses the magnitude of the inertia-induced torque from being excessively increased and suppresses the time period when the inertia-induced torque is produced from being excessively shortened. Suppressing the magnitude of the inertia-induced torque from being excessively increased results in suppressing the magnitude of the transmission torque Tmp from being excessively increased and suppresses an increase in total loss of the vehicle, thus suppressing reduction of the total energy efficiency of the vehicle.

In the case of motoring the engine 22 by the motor MG1 in reverse driving, the hybrid vehicle 20 of the embodiment sets the required rotation speed Netag to provide a larger value at the lower required torque Tr* (larger absolute value) than a value at the higher required torque Tr* (smaller absolute value) and increases the target rotation speed Ne* of the engine 22 toward the required rotation speed Netag by using the rate of increase Rup. This ensures some time period when the inertia-induced torque is produced, even in the case of a relatively low required torque Tr*.

In the reverse driving, when the required torque Tr* becomes less than the rated torque Tm2lim of the motor MG2 (i.e., when the absolute value of the required torque Tr* becomes larger than the absolute value of the rated torque Tm2lim), the hybrid vehicle 20 of the embodiment starts motoring the engine 22 by the motor MG1. According to a modification, in the reverse driving, when the required torque Tr* becomes less than a threshold value that is slightly larger than the rated torque Tm2lim of the motor MG2, motoring the engine 22 by the motor MG1 may be started. According to another modification, in the reverse driving, motoring the engine 22 by the motor MG1 may be started, irrespective of the required torque Tr*.

In the reverse driving, when the required torque Tr* becomes less than the rated torque Tm2lim of the motor MG2 and subsequently increases to or above the rated torque Tm2lim, the hybrid vehicle 20 of the embodiment continues motoring the engine 22 by the motor MG1. According to a modification, in the reverse driving, when the required torque Tr* increases to or above the rated torque Tm2lim during motoring the engine 22 by the motor MG1, motoring the engine 22 by the motor MG1 may be stopped.

The hybrid vehicle 20 of the embodiment sets the required rotation speed Netag of the engine 22 to increase with a decrease in required torque Tr* or more specifically to provide a larger value at the lower required torque Tr* (larger value for reverse driving) than a value at the higher required torque Tr* in the reverse driving. According to a modification, in the reverse driving, the required rotation speed Netag of the engine 22 may be set without taking into account the required torque Tr*.

The following describes the correspondence relationship between the primary components of the embodiment and the primary components of the present disclosure described in Summary. The engine 22 of the embodiment corresponds to the “engine”; the motor MG1 corresponds to the “first motor”; the planetary gear 30 corresponds to the “planetary gear”; the motor MG2 corresponds to the “second motor”; and the battery 50 corresponds to the “battery”. The EVECU 70, the engine ECU 24 and the motor ECU 40 correspond to the “controller”.

The correspondence relationship between the primary components of the embodiment and the primary components of the present disclosure, regarding which the problem is described in Summary, should not be considered to limit the components of the present disclosure, regarding which the problem is described in Summary, since the embodiment is only illustrative to specifically describes the aspects of the present disclosure, regarding which the problem is described in Summary. In other words, the present disclosure, regarding which the problem, is described in Summary, should be interpreted on the basis of the description in the Summary, and the embodiment is only a specific example of the present disclosure, regarding which the problem is described in Summary.

The aspect of the present disclosure is described above with reference to the embodiment. The present disclosure is, however, not limited to the above embodiment but various modifications and variations may be made to the embodiment without departing from the scope of the present disclosure.

In some embodiments, the technique of the present disclosure is applicable to the manufacturing industries of hybrid vehicle.

1. A hybrid vehicle, comprising
an engine;
a first motor that is configured to input and output power;
a planetary gear that is configured to have three rotational elements respectively connected with a rotating shaft of the first motor, an output shaft of the engine and a driveshaft linked with an axle, such that the rotating shaft, the output shaft anon the driveshaft are arrayed in this sequence on a collinear diagram;
a second motor that is configured to input and output power to and from the driveshaft;
a battery that is configured to transmit electric power to and from the first motor and the second motor; and
a controller that is configured to control at least the second motor in reverse driving such that the hybrid vehicle runs according to a required torque for running, wherein
in the case of motoring the engine without fuel injection by the first motor in reverse driving, the controller sets a target rate of increase which denotes a target value of an amount of increase in rotation speed of the engine per unit time, such as to provide a larger value at a larger absolute value of the required torque than a value at a smaller absolute value of the required torque, and controls the first motor to increase rotation speed of the engine by the target rate of increase.

2. The hybrid vehicle according to claim 1,
wherein the controller starts motoring the engine by the first motor when the absolute value of the required torque becomes larger than a threshold value in reverse driving.

3. The hybrid vehicle according to claim 1,
wherein in the case of motoring the engine by the first motor in reverse driving, the controller sets a required rotation speed such as to provide a larger value at the larger absolute value of the required torque than a value at the smaller absolute value of the required torque and controls the first motor to increase the rotation speed of the engine to the required rotation speed.

4. The hybrid vehicle according to claim 2,
wherein in the case of motoring the engine by the first motor in reverse driving, the controller sets a required rotation speed such as to provide a larger value at the larger absolute value of the required torque than a value at the smaller absolute value of the required torque and controls the first motor to increase the rotation speed of the engine to the required rotation speed.
